(19) United States
(12) Patent Application Publication
(10) Pub. No.: US 2025/0109017 A1
(43) Pub. Date: Apr. 3, 2025

(54) HIGH ENTROPY ALLOY CATALYST FOR PRODUCTION OF HYDROGEN FROM AMMONIA

(71) Applicant: SAUDI ARABIAN OIL COMPANY, Dhahran (SA)

(72) Inventors: Sehmus OZDEN, Houston, TX (US); Ashok SANTRA, The Woodlands, TX (US); Feng LIANG, Houston, TX (US); Atieh H. ABU RAQABAH, Houston, TX (US)

(73) Assignee: SAUDI ARABIAN OIL COMPANY, Dhahran (SA)

(21) Appl. No.: 18/480,440

(22) Filed: Oct. 3, 2023

(51) Int. Cl. C01B 3/04

(52) U.S. Cl. CPC C01B 3/047; C01B 2203/0277

(57) ABSTRACT

Hydrogen may be produced from ammonia by catalytic reaction. For example, a method of hydrogen production may include: introducing ammonia to a reactor, wherein the reactor includes therein a catalyst, wherein the catalyst includes a high entropy alloy, and wherein the high entropy alloy has an entropy, S, such that S≥11.31 J K⁻¹ mol⁻¹; reacting the ammonia in the presence of the catalyst to form hydrogen gas and nitrogen gas; and separating the hydrogen gas from the nitrogen gas to produce a hydrogen stream including the hydrogen gas from the reactor.

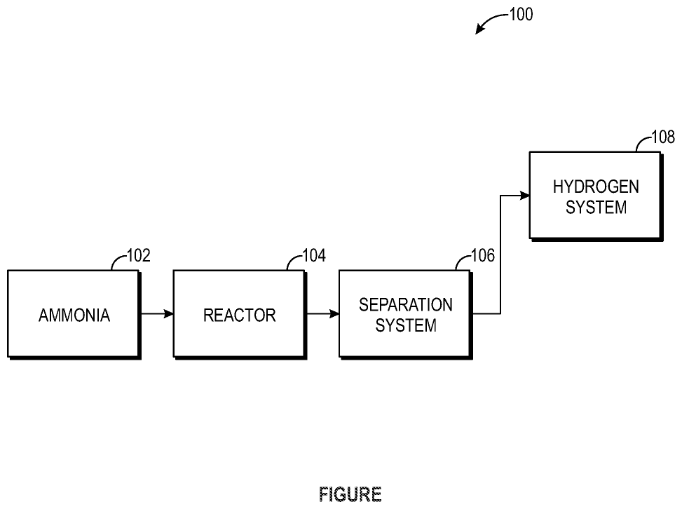

### FIELD OF THE DISCLOSURE

The present disclosure relates generally to production of hydrogen and, more particularly to production of hydrogen from ammonia.

### BACKGROUND OF THE DISCLOSURE

Hydrogen is an emerging clean fuel source with potential to power energy storage, electrical production, vehicle propulsion, and other applications. Hydrogen can be converted to usable energy (including electrical energy) with low or no carbon dioxide emissions using technologies such as fuel cells, as the product of hydrogen used in fuel cells is water, heat, and electricity.

Methane derived from natural gas is the current conventional source for a majority of hydrogen production. Conventional methods of producing hydrogen include steam methane reforming (SMR), autothermal methane reforming (ATR), and partial oxidation of methane (POM). SMR, ATR and POM have a primary disadvantage of high CO₂ emissions that negate the clean-burning advantages of using hydrogen as a fuel source. Additional disadvantages of conventional hydrogen production methods include high energy consumption, high cost, low reaction efficiency, low process stability, and low efficiency of catalyst.

Conventional production of hydrogen (including ATR, SMR, POM, and catalysis of methane without oxygen) may involve use of conventional catalyst technology. Catalyst efficiency is one of the key issues with efficient hydrogen production. Conventional catalysts such as monometallic, bimetallic noble, non-noble metal catalysts, and non-metal catalysts may have limited efficiency and limited lifespan due to the compositions of the catalyst, size effects, surface area effects, porosity, defect density, promotor effects, support effects, coordination state of metal in the catalyst, acid-base properties of the catalyst, or any combination thereof.

Once produced, hydrogen has a low gravimetric energy density and may be difficult to handle because of its low liquefaction temperature. Various hydrogen carriers have been studied, including ammonia. In particular, ammonia has a low liquefaction pressure at room temperature, and it can be stored and transported efficiently. Additionally, ammonia is carbon dioxide-free and has a 17 wt % higher gravimetric storage capacity for hydrogen as compared to other liquid organic hydrogen carriers.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A first nonlimiting example method of the present disclosure includes: introducing ammonia to a reactor, wherein the reactor contains therein a catalyst, wherein the catalyst comprises a high entropy alloy, and wherein the high entropy alloy has an entropy, S, such that S≥11.31 J K⁻¹ mol⁻¹; reacting the ammonia in the presence of the catalyst to form hydrogen gas and nitrogen gas; and separating the hydrogen gas from the nitrogen gas to produce a hydrogen stream comprising the hydrogen gas from the reactor.

A first nonlimiting example system of the present disclosure includes: a reactor, wherein the reactor contains therein a catalyst, wherein the catalyst comprises a high entropy alloy, and wherein the high entropy alloy has an entropy, S, such that S≥11.31 J K⁻¹ mol⁻¹, and wherein the reactor reacts ammonia in the presence of the catalyst to form hydrogen gas and nitrogen gas; and a separation system, wherein the separation system separates the hydrogen gas from the nitrogen to produce a hydrogen stream comprising the hydrogen gas.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The FIGURE illustrates a diagram of a nonlimiting system for producing hydrogen according to the present disclosure.

### DETAILED DESCRIPTION

Embodiments of the present disclosure will now be described in detail with reference to the accompanying FIGURES. Like elements in the various FIGURES may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying FIGURES may vary without departing from the scope of the present disclosure.

Embodiments in accordance with the present disclosure generally relate to production of hydrogen and, more particularly, to catalytic production of hydrogen from ammonia.

The present disclosure provides methods and systems for hydrogen production from ammonia utilizing a catalyst that includes a high entropy alloy. The high entropy alloy catalyst system may allow for high catalyst stability and high conversion of ammonia to hydrogen gas with high specificity. Conversion of ammonia to hydrogen gas may occur according to Reaction 1 below.

2NH₃(g)⇄N₂(g)+3H₂(g) Reaction 1

wherein the reaction of ammonia to form hydrogen gas and nitrogen gas has an enthalpy of reaction, ΔH°=92 KJ mol⁻¹.

“Catalyst,” “catalytic,” “catalysis,” and grammatical variants thereof, as used herein, refers to a chemical compound (or process of using such a chemical compound) that increases the rate of a chemical reaction without being consumed during the reaction. A catalyst may comprise additional components such as, for example, a secondary phase, a catalyst support, a catalyst promotor, the like, or any combination thereof.

“High entropy alloy catalyst” as used herein refers to a catalyst that comprises a high entropy alloy. A high entropy alloy catalyst may comprise additional components as described for a catalyst above.

“High entropy alloy” as used herein, refers to a catalytic composition that has a mixed configuration entropy, S, of S≥11.31 J K⁻¹ mol⁻¹ and/or a catalytic composition comprising a metal alloy whose composition consists of five or more metal elements, with each element having a concentration of from 0.1 atomic percent (at %) to 50 at %.

Mixed configuration entropy, S, of a composition (e.g., an alloy) that includes more than one elemental species is typically calculated according to Equation 1 below.

$$S = - R \sum {x}_{i} ln ( {x}_{i} ) \qquad Equation 1$$

where R is the molar gas constant (equal to about 8.314 J K⁻¹ mol⁻¹), and xi is a mole fraction of an individual elemental species (e.g., an individual metal). Equation 1 may be simplified for alloys with an equimolar ratio of elements to Equation 2 below.

$$S = R ln n \qquad Equation 2$$

where n is the number of individual elemental species present in the alloy.

An alloy may be considered a high entropy alloy if the entropy, S, is greater than the entropy of mixed configuration of an equimolar compound with 4 species, or preferably 5 species. If the number of equimolar elemental species present is 4 then S=1.36R. In a more preferred case, the number of equimolar elemental species present may be 5, and thus S=1.5R. Thus, if the alloy has an entropy S, such that S≥1.36R, equaling to S≥11.31 J K⁻¹ mol⁻¹, the alloy can be considered a high entropy alloy.

The high entropy alloys that are suitable for use in catalysts for hydrogen production in accordance with the present disclosure may comprise metals including, but not limited to, cobalt, chromium, iron, manganese, nickel, aluminum, magnesium, copper, zinc, zirconium, ruthenium, rhodium, palladium, silver, tungsten, rhenium, iridium, platinum, gold, cerium, ytterbium, tin, calcium, beryllium, the like, or any combination thereof. It should be noted that the high entropy alloy may comprise 4 or more (or 4, or 4 to 30, or preferably 5 or more, or 5, or 5 to 6, or 5 to 7, or 5 to 8, or 5 to 9, or 5 to 10, or 5 to 15, 5 to 20, or 5 to 25) suitable metals in any combination. Each metal in the high entropy alloy may comprise from 0.1 at % to 50 at % (or 0.1 at % to 20 at %, or 0.1 at % to 40 at %, or 0.1 at % to 25 at %, or 1 at % to 25 at %, or 5 at % to 35 at %) of the high entropy alloy.

The high entropy alloys may have a metal crystalline structure including, but not limited to, a face centered cubic (FCC), a body centered cubic (BCC), a hexagonal close packed (HCP) structure, the like, or any combination thereof. Furthermore, high entropy alloys of the present disclosure may have an amorphous structure or may have a structure comprising a combination of crystalline metal and amorphous components.

The inclusion of a high entropy alloy in the catalyst may provide additional features to the catalyst including increased activity and decreased adsorption energy. Without being bound by theory, it is believed that the presence of additional elements contributing to the high entropy of the high entropy catalyst allows for additional atomic arrangements on the surface of the catalyst, allowing for increased adsorption to the surface of the catalyst.

The high entropy alloy may be manufactured using synthesis in solid phase, liquid phase, gas phase, or any combination thereof. The synthesis method used may comprise any suitable method of manufacturing a high entropy alloy including, but not limited to, a wet-chemical method, sol-gel auto-combustion, spray pyrolysis, carbothermal shock synthesis, a hydrothermal method, pulse-laser ablation, mechanical milling, arc melting, induction melting, a metal spray technique, molecular beam epitaxy, atomic layer deposition, chemical vapor deposition, pulsed laser deposition, the like, or any combination thereof.

A catalyst support may be included in the catalyst. “Catalyst support” and grammatical variants thereof, as used herein, refers to a compound or material to which the catalyst is affixed for providing additional features. The catalyst support used in the present disclosure may comprise any suitable catalyst support material including, but not limited to, a metal, a metal oxide, a zeolite, carbon black, a secondary phase, the like, or any combination thereof. Suitable metal oxides may include, but are not limited to, Al₂O₃, Al₂O₄, SiO₂, MgO, TiO₂, Fe₂O₃, FeO, ZrO₂, CeO₂, a lanthanide oxide (e.g., Er₂O₃), the like, or any combination thereof. The catalyst may comprise from 0.0001 at % to 50 at % (or 0.0001 at % to 20 at %, or 0.0001 at % to 40 at %) of the catalyst support. The catalyst support may be an internal catalyst support, an external catalyst support, or any combination thereof. An “internal catalyst support” as used herein refers to the catalyst support being embedded in the high entropy alloy structure. As a nonlimiting example, a catalyst with an internal catalyst support may comprise nanoparticles of silica where more than one nanoparticle of silica is on the surface of and/or within parts of a single catalyst particle, thus the silica nanoparticles comprise an internal catalyst support. An “external catalyst support” as used herein refers to a catalyst support that is external to the structure of the high entropy alloy. As a nonlimiting example, a catalyst with an external catalyst support may comprise an Au/TiO₂ catalyst, wherein the Au acts catalytically and the TiO₂ forms a large particle external to the Au, the TiO₂ thus acting as an external catalyst support.

The catalyst support, when added to the catalyst, may serve to increase the efficiency of the catalysis. The catalyst support may provide features to the catalyst such as, for example, increasing alloy dispersion, improving sintering resistance, increasing the rate of reactant adsorption, or any combination thereof. The catalyst support may additionally prevent impurity deposition (e.g., coke formation) on the surface of the catalyst, maintaining increased catalyst activity for a longer time duration. The catalyst support may function by interacting chemically, physically, or chemically and physically, with the other components of the catalyst, a reaction substrate, or any combination thereof.

A catalyst promotor may be included in the catalyst. “Catalyst promotor” and grammatical variants thereof, as used herein, refers to a compound provided with a catalyst for increasing the catalytic activity of the catalyst. The catalyst promotor used in the present disclosure may comprise any suitable catalyst promotor material including, but not limited to, a metal, a metal oxide, a secondary phase, the like, or any combination thereof. Suitable catalyst promotor materials may include, but are not limited to, an alkali metal (e.g., lithium, sodium, potassium, cesium, francium, or any combination thereof), an alkali earth metal (e.g., calcium, magnesium, barium, or any combination thereof), a transition metal (e.g., iron, cobalt, manganese, magnesium, nickel, molybdenum, copper, palladium, platinum, rhenium, or any combination thereof), a post-transition metal (e.g., aluminum, gallium, or any combination thereof), a cerium compound (e.g., cerium, a cerium oxide (e.g., Ce₂O₃, CeO₂, or any combination thereof), or any combination thereof), a lanthanide (e.g., lanthanum, neodymium, or any combination thereof), a metal oxide (e.g., MgO, Ca₂SiO₄, CaO, or any combination thereof), a germanium compound, the like, or any combination thereof. The catalyst promotor may comprise from 0.0001 at % to 50 at % (or 0.0001 at % to 20 at %, or 0.0001 at % to 40 at %) of the catalyst. The catalyst promotor may be an internal catalyst promotor, an external catalyst promotor, or any combination thereof. An “internal catalyst promotor” as used herein refers to wherein the catalyst promotor is embedded in the high entropy alloy structure. An “external catalyst promotor” as used herein refers to a catalyst promotor that is external to the structure of the high entropy alloy.

The catalyst promotor used in the present disclosure may serve as a chemical promotor, a structural promotor, or any combination thereof. When serving as a chemical promotor, the catalyst promotor may improve the efficiency of the catalyst by, without being bound by theory, altering the distribution of electrons at the surface of the catalyst. When serving as a structural promotor, the catalyst promotor may alter mechanical properties of the catalyst such as, for example, increase sintering resistance. The catalyst promotor may also provide additional features such as increasing selectivity of the catalyst for a particular reactant. Without being bound by theory, the catalyst promotor may increase adsorption and chemisorption for a specific reactant at an active site of the catalyst, thus increasing selectivity. The catalyst promotor may also increase the durability of the catalyst.

It should be noted that in some embodiments the catalyst promotor may be a metal that in other embodiments may be a catalyst support, and yet in other embodiments may comprise the high entropy alloy. In other words, a single metal may provide catalytic activity in some embodiments, may serve as a catalyst promotor in other embodiments, and may serve as a catalyst support in yet other embodiments. Without being bound by theory, the function of a metal may be determined by other components in the catalyst and interactions with the other elements and compounds. By way of an illustrative nonlimiting example, in a first case a catalyst may comprise a high entropy alloy wherein the high entropy alloy comprises nickel, aluminum, magnesium, copper, and zinc, and wherein the catalyst further comprises zirconium as an internal catalyst promotor. Continuing the nonlimiting example, in a second case a catalyst may comprise a high entropy alloy wherein the high entropy alloy comprises nickel, aluminum, rhodium, silver, and palladium, and wherein the catalyst further comprises copper as an internal catalyst promotor. Continuing the nonlimiting example, in a third case a catalyst may comprise a high entropy alloy wherein the high entropy alloy comprises nickel, aluminum, zirconium, palladium, and zinc, and wherein the catalyst further comprises copper as a catalyst support. In the aforementioned nonlimiting example, copper may, depending on the embodiment, comprise the high entropy alloy, may serve as a catalyst promotor, or may serve as a catalyst support.

The catalysts described herein may also further comprise a secondary phase. The secondary phase may interact with any component of the catalyst and may provide features such as increased catalytic activity to the catalyst. As noted above, the secondary phase or portions thereof may serve as a catalyst promotor, a catalyst support, or any combination thereof. The secondary phase may comprise any suitable composition including, but not limited to, an intermetallic phase, a laves phase, a carbide phase, a boride phase, a borocarbide phase, a nitride phase, a silicide phase, an aluminide phase, an oxide phase (e.g., MgO, Al₂O₃, or any combination thereof), a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof.

The catalyst may be present in the form of a plurality of particles. The plurality of particles may have an average dimension from 1 nanometer (nm) to 999 micrometers (μm) (or 1 nm to 500 μm, or 1 nm to 10 μm, or 1 nm to 999 nm, or 1 μm to 999 μm). The average dimension of the plurality of particles may be defined as the average width, length, height, diameter, or any combination thereof of a particle. The particles may be of any shape including, but not limited to, spherical, cubic, triangular, oblong, irregular, or any combination thereof. The plurality of particles may be formed to a catalyst bead, catalyst pellet, or any combination thereof in any suitable shape and size.

The catalyst may further comprise a non-stick additive. The non-stick additive may prevent sticking of carbon and/or any other impurities formed during reaction to the catalyst, potentially maintaining the activity of the catalyst for an extended period of time, reducing the need to clean or replace the catalyst, thus reducing costs. The non-stick additive may comprise any suitable material including, but not limited to, a magnesium silicate, a borosilicate, a borate, aluminum oxide, silicon dioxide, titanium oxide, zirconium oxide, the like, or any combination thereof.

The present disclosure furthermore includes methods and systems of hydrogen production utilizing the catalysts described above.

A diagram illustrating a nonlimiting system of the present disclosure is illustrated in the FIGURE. The system 100 may comprise wherein the ammonia 102 is introduced to a reactor 104, wherein the reactor 104 contains therein the catalyst. The system 100 may further comprise wherein the ammonia 102 reacts in the presence of the catalyst to form hydrogen gas and nitrogen gas. The system 100 may further comprise a separation system 106 for separating the hydrogen gas from the nitrogen gas to produce a hydrogen stream 108 comprising the hydrogen gas from the reactor.

The reactor may be a reactor such as, for example, an ammonia decomposition reactor. The reactor may be any suitable configuration of reactor including, but not limited to, a packed bed reactor, a fluidized bed reactor, a membrane reactor, the like, or any combination thereof. The reactor may have one or more catalyst beds contained therein, the one or more catalyst beds comprising the catalyst. The pressure of the reactor may be from 1 bar to 25 bar (or 1 bar to 20 bar, or 1 bar to 10 bar, or 5 bar to 15 bar, or 10 bar to 20 bar, or 15 bar to 25 bar, or 0.1 bar to 25 bar). The temperature of the reactor may be from 300° C. to 1200° C. (or 300° C. to 600° C., or 300° C. to 900° C., or 900° C. to 1200° C., or 100° C. to 1400° C., or 200° C. to 600° C., or 400° C. to 600° C., or 1000° C. to 1200° C., or 500° C. to 800° C., or 600° C. to 800° C., or 850° C. to 950° C., or 700° C. to 1000° C.).

The ammonia may further comprise an inert carrier (e.g., nitrogen gas, argon, the like, or any combination thereof). While in the reactor, the ammonia is catalyzed by the catalyst to form the hydrogen gas and nitrogen gas. It should be noted that other impurities may be formed in the reactor in addition to the hydrogen gas and nitrogen gas and may be intermixed with the hydrogen gas, the nitrogen gas, or both.

Separating the hydrogen gas from the nitrogen gas to produce a hydrogen stream may comprise passing the hydrogen gas through a separation system that may comprise, for example, a separation membrane. The separation membrane may separate the hydrogen gas from the nitrogen gas, impurities (e.g., unreacted ammonia, the like, or any combination thereof), side products formed during reaction, the like, or any combination thereof. Any suitable separation membrane may be used. The separation system including the separation membrane may be housed within the reactor or may be external to the reactor.

The system may have a conversion efficiency of from 20% to 99.9% (or 20% to 60%, or 60% to 99.9%, or greater than 99.9%). Conversion efficiency, CE, may be calculated by Equation 3 below.

$$CE = ( {R}_{FEED} - {R}_{OUTLET} ) / {R}_{FEED} * 100 \qquad Equation 3$$

where R_{FEED} is the quantity of reactant in the feed, and R_{OUTLET} is the quantity of reactant in the outlet.

The product hydrogen stream may be of any suitable purity including from 90 mol % to 99.99 mol % purity (or 60 mol % to 99.99 mol %, or 80 mol % to 99.99 mol %, or 95 mol % to 99.99 mol %, or 99.99 mol % or greater). The hydrogen stream may be provided at any suitable temperature and pressure. The pressure and temperature of the hydrogen stream may be affected by the pressure and temperature of the reactor, the separation system, or any combination thereof. The hydrogen stream may subsequently be directed from the separation system to any suitable location including, but not limited to, a pipeline, a storage tank, a railcar tank, the like, or any combination thereof.

The hydrogen stream may be of any suitable purity including from 90 mol % to 99.99 mol % percent purity (or 60 mol % to 99.99 mol %, or 80 mol % to 99.99 mol %, or 95 mol % to 99.99 mol %). The hydrogen stream may be provided at any suitable temperature and pressure. The pressure and temperature of the hydrogen stream may be affected by the pressure and temperature of the reactor. The hydrogen stream may subsequently be directed from the pressure swing adsorption unit to any suitable location including, but not limited to, a pipeline, a storage tank, a railcar tank, the like, or any combination thereof.

Any of the reactors described in any system above may contain a heating system to heat the reactor. The heating system of the reactor may require extensive thermal duty, and thus use of a heating method with lower carbon dioxide emissions may be preferred, though any suitable heating method may be used. Suitable heating methods for use in the present disclosure may include, but are not limited to, hydrocarbon heating, induction heating, plasma heating (e.g., microwave plasma), microwave heating, solar furnace heating, the like, or any combination thereof.

Hydrocarbon heating may comprise burning a hydrocarbon such as, for example, natural gas, gasoline, or any combination thereof in order to provide thermal energy. It should be noted that any suitable heat conduction material, heat transfer fluid, or any combination thereof, may be used to convey heat energy from the burning of the hydrocarbon to the reactor.

The heating system may comprise induction heating. In an induction heating system an electrical current may flow through metal coils to heat metal within the catalyst through electromagnetic induction. Induction heating may increase efficiency of heating by reducing waste heat loss, thus improving the energy efficiency of the reactor.

Plasma heating may comprise a system wherein heat is provided through heating of gasses within the reactor to produce plasma. Microwave heating may comprise a system wherein metal coils are used to produce microwave radiation, heating species within the reactor. Solar furnace heating may comprise a system that utilizes thermal energy from solar radiation and conveys the solar radiation thermal energy to the reactor in order to heat the reactor.

It should be appreciated that one skilled in the art should be able to, with the benefit of this disclosure, implement the methods and systems described above. It should be noted that additional nonlimiting components may be utilized in the methods and systems described above to produce hydrogen. Such additional components will be familiar to one having ordinary skill in the art and may include, but are not limited to, valves, pumps, joints, sensors, compressors, controllers, heat exchangers, the like, or any combination thereof.

### Additional Embodiments

Embodiments disclosed herein include:

Embodiment 1. A method comprising: introducing ammonia to a reactor, wherein the reactor contains therein a catalyst, wherein the catalyst comprises a high entropy alloy, and wherein the high entropy alloy has an entropy, S, such that S≥11.31 J K⁻¹ mol⁻¹; reacting the ammonia in the presence of the catalyst to form hydrogen gas and nitrogen gas; and separating the hydrogen gas from the nitrogen gas to produce a hydrogen stream comprising the hydrogen gas from the reactor.

Embodiment 2. The method of Embodiment 1, wherein the high entropy alloy comprises 5 or more metals.

Embodiment 3. The method of Embodiment 2, wherein each of the 5 or more metals has a composition in the high entropy alloy from 0.1 at % (atomic percentage) to 50 at %.

Embodiment 4. The method of Embodiment 2 or 3, wherein the 5 or more metals are selected from a group consisting of: cobalt, chromium, iron, manganese, nickel, aluminum, magnesium, copper, zinc, zirconium, ruthenium, rhodium, palladium, silver, tungsten, rhenium, iridium, platinum, gold, cerium, ytterbium, tin, calcium, and beryllium.

Embodiment 5. The method of any one of Embodiments 1-4, wherein the catalyst further comprises a secondary phase.

Embodiment 6. The method of Embodiment 5, wherein the secondary phase comprises an intermetallic phase, a laves phase, a carbide phase, a boride phase, a borocarbide phase, a nitride phase, a silicide phase, an aluminide phase, an oxide phase, a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof.

Embodiment 7. The method of any one of Embodiments 1-6, wherein the high entropy alloy comprises a catalyst support.

Embodiment 8. The method of Embodiment 7, wherein the catalyst support comprises a metal oxide.

Embodiment 9. The method of any one of Embodiments 1-8, wherein the high entropy alloy comprises a catalyst promotor.

Embodiment 10. The method of any one of Embodiments 1-9, wherein the catalyst further comprises an external catalyst support.

Embodiment 11. The method of any one of Embodiments 1-10, wherein the catalyst further comprises an external catalyst promotor.

Embodiment 12. The method of any one of Embodiments 1-11, wherein the catalyst is located in a catalyst bed contained within the reactor.

Embodiment 13. The method of any one of Embodiments 1-12, wherein separating the hydrogen gas from the nitrogen gas comprises using a separation membrane.

Embodiment 14. The method of any one of Embodiments 1-13, wherein the reactor is heated by hydrocarbon heating, induction heating, plasma heating, microwave heating, solar furnace heating, or any combination thereof.

Embodiment 15. The method of any one of Embodiments 1-14, wherein a pressure of the reactor is from 1 bar to 25 bar.

Embodiment 16. The method of any one of Embodiments 1-15, wherein a temperature of the reactor is from 300° C. to 1200° C.

Embodiment 17. The method of any one of Embodiments 1-16, wherein the catalyst further comprises a non-stick additive, and wherein the non-stick additive comprises a magnesium silicate, a boron silicate, a borate silicate, aluminum oxide, silicon dioxide, titanium oxide, zirconium oxide, or any combination thereof.

Embodiment 18. A system comprising: a reactor, wherein the reactor contains therein a catalyst, wherein the catalyst comprises a high entropy alloy, and wherein the high entropy alloy has an entropy, S, such that S≥11.31 J K⁻¹ mol⁻¹, and wherein the reactor reacts ammonia in the presence of the catalyst to form hydrogen gas and nitrogen gas; and a separation system, wherein the separation system separates the hydrogen gas from the nitrogen to produce a hydrogen stream comprising the hydrogen gas.

Embodiment 19. The system of Embodiment 18, wherein the high entropy alloy comprises 5 or more metals.

Embodiment 20. The system of Embodiment 19, wherein each of the 5 or more metals has a composition in the high entropy alloy from 0.1 at % (atomic percentage) to 50 at %.

Embodiment 21. The system of Embodiment 19 or 20, wherein the 5 or more metals are selected from a group consisting of: cobalt, chromium, iron, manganese, nickel, aluminum, magnesium, copper, zinc, zirconium, ruthenium, rhodium, palladium, silver, tungsten, rhenium, iridium, platinum, gold, cerium, ytterbium, tin, calcium, and beryllium.

Embodiment 22. The system of any one of Embodiments 18-21, wherein the catalyst further comprises a secondary phase.

Embodiment 23. The system of Embodiment 22, wherein the secondary phase comprises an intermetallic phase, a laves phase, a carbide phase, a boride phase, a borocarbide phase, a nitride phase, a silicide phase, an aluminide phase, an oxide phase, a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof.

Embodiment 24. The system of any one of Embodiments 18-23, wherein the high entropy alloy comprises a catalyst support.

Embodiment 25. The system of Embodiment 24, wherein the catalyst support comprises a metal oxide.

Embodiment 26. The system of any one of Embodiments 18-25, wherein the high entropy alloy comprises a catalyst promotor.

Embodiment 27. The system of any one of Embodiments 18-26, wherein the catalyst further comprises an external catalyst support.

Embodiment 28. The system of any one of Embodiments 18-27, wherein the catalyst further comprises an external catalyst promotor.

Embodiment 29. The system of any one of Embodiments 18-28, wherein the catalyst is located in a catalyst bed contained within the reactor.

Embodiment 30. The system of any one of Embodiments 18-29, wherein the separation system comprises a separation membrane.

Embodiment 31. The system of any one of Embodiments 18-30, wherein the reactor is heated by hydrocarbon heating, induction heating, plasma heating, microwave heating, solar furnace heating, or any combination thereof.

Embodiment 32. The system of any one of Embodiments 18-31, wherein a pressure of the reactor is from 1 bar to 25 bar.

Embodiment 33. The system of any one of Embodiments 18-32, wherein a temperature of the reactor is from 300° C. to 1200° C.

Embodiment 34. The system of any one of Embodiments 18-33, wherein the catalyst further comprises a non-stick additive, and wherein the non-stick additive comprises a magnesium silicate, a boron silicate, a borate silicate, aluminum oxide, silicon dioxide, titanium oxide, zirconium oxide, or any combination thereof.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
introducing ammonia to a reactor, wherein the reactor contains therein a catalyst, wherein the catalyst comprises a high entropy alloy, and wherein the high entropy alloy has an entropy, S, such that S≥11.31 J K⁻¹ mol⁻¹;
reacting the ammonia in the presence of the catalyst to form hydrogen gas and nitrogen gas; and
separating the hydrogen gas from the nitrogen gas to produce a hydrogen stream comprising the hydrogen gas from the reactor.

2. The method of claim 1, wherein the high entropy alloy comprises 5 or more metals, and wherein each of the 5 or more metals has a composition in the high entropy alloy from 0.1 at % (atomic percentage) to 50 at %.

3. The method of claim 2, wherein the 5 or more metals are selected from a group consisting of: cobalt, chromium, iron, manganese, nickel, aluminum, magnesium, copper, zinc, zirconium, ruthenium, rhodium, palladium, silver, tungsten, rhenium, iridium, platinum, gold, cerium, ytterbium, tin, calcium, and beryllium.

4. The method of claim 1, wherein the catalyst further comprises a secondary phase, wherein the secondary phase comprises an intermetallic phase, a laves phase, a carbide phase, a boride phase, a borocarbide phase, a nitride phase, a silicide phase, an aluminide phase, an oxide phase, a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof.

5. The method of claim 1, wherein the high entropy alloy comprises a catalyst support.

6. The method of claim 1, wherein the high entropy alloy comprises a catalyst promotor.

7. The method of claim 1, wherein the catalyst further comprises an external catalyst support.

8. The method of claim 1, wherein the catalyst further comprises an external catalyst promotor.

9. The method of claim 1, wherein the catalyst further comprises a non-stick additive, and wherein the non-stick additive comprises a magnesium silicate, a boron silicate, a borate silicate, aluminum oxide, silicon dioxide, titanium oxide, zirconium oxide, or any combination thereof.

10. The method of claim 1, wherein a pressure of the reactor is from 1 bar to 25 bar.

11. The method of claim 1, wherein a temperature of the reactor is from 300° C. to 1200° C.

12. A method comprising:
introducing ammonia to a reactor, wherein the reactor contains therein a catalyst, wherein the catalyst comprises a high entropy alloy, wherein the high entropy alloy has an entropy, S, such that S≥11.31 J K⁻¹ mol⁻¹, wherein the high entropy alloy comprises 5 or more metals, wherein each of the 5 or more metals has a composition in the high entropy alloy from 0.1 at % (atomic percentage) to 50 at %; and wherein the 5 or more metals are selected from a group consisting of: cobalt, chromium, iron, manganese, nickel, aluminum, magnesium, copper, zinc, zirconium, ruthenium, rhodium, palladium, silver, tungsten, rhenium, iridium, platinum, gold, cerium, ytterbium, tin, calcium, and beryllium;
reacting the ammonia in the presence of the catalyst to form hydrogen gas and nitrogen gas; and
separating the hydrogen gas from the nitrogen gas to produce a hydrogen stream comprising the hydrogen gas from the reactor.

13. A system comprising:
a reactor, wherein the reactor contains therein a catalyst, wherein the catalyst comprises a high entropy alloy, and wherein the high entropy alloy has an entropy, S, such that S≥11.31 J K⁻¹ mol⁻¹, and wherein the reactor reacts ammonia the presence of the catalyst to form hydrogen gas and nitrogen gas; and
a separation system, wherein the separation system separates the hydrogen gas from the nitrogen to produce a hydrogen stream comprising the hydrogen gas.

14. The system of claim 13, wherein the high entropy alloy comprises 5 or more metals, and wherein each of the 5 or more metals has a composition in the high entropy alloy from 0.1 at % (atomic percentage) to 50 at %.

15. The system of claim 14, wherein the 5 or more metals are selected from a group consisting of: cobalt, chromium, iron, manganese, nickel, aluminum, magnesium, copper, zinc, zirconium, ruthenium, rhodium, palladium, silver, tungsten, rhenium, iridium, platinum, gold, cerium, ytterbium, tin, calcium, and beryllium.

16. The system of claim 13, wherein the catalyst further comprises a secondary phase, wherein the secondary phase comprises an intermetallic phase, a laves phase, a carbide phase, a boride phase, a borocarbide phase, a nitride phase, a silicide phase, an aluminide phase, an oxide phase, a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof.

17. The system of claim 13, wherein the high entropy alloy comprises a catalyst support.

18. The system of claim 13, wherein the high entropy alloy comprises a catalyst promotor.

19. The system of claim 13, wherein the catalyst is located in a catalyst bed contained within the reactor.

20. The system of claim 13, wherein the catalyst further comprises a non-stick additive, and wherein the non-stick additive comprises a magnesium silicate, a boron silicate, a borate silicate, aluminum oxide, silicon dioxide, titanium oxide, zirconium oxide, or any combination thereof.
